(19) United States
(12) Patent Application Publication
(10) Pub. No.: US 2010/0215424 A1
(43) Pub. Date: Aug. 26, 2010

(54) LOCKING DEVICE WITH A SHAPE MEMORY ALLOY ACTUATOR AND METHOD OF USE

(75) Inventors: R. Kim Crookston, Valencia, CA (US); Mark A. Woodruff, Valencia, CA (US)

Correspondence Address: Bainwood, Huang & Associates, LLC, 2 Connector Road, Westborough, MA, 01581, US

(73) Assignee: HR TEXTRON INC., Santa Clarita, CA (US)

(21) Appl. No.: 12/391,555

(22) Filed: Feb. 24, 2009

(51) Int. Cl. F16D 1/00; H02N 10/00

(52) U.S. Cl. 403/6; 310/306

(57) ABSTRACT

A locking device includes a shape memory alloy actuator that engages a locking pin to release the pin and unlock the device it is engaging. Upon heating the shape memory alloy member, it returns to a predetermined shape, which has a length shorter than its non-heated length. As the shape memory alloy actuator shortens, it pulls the locking pin at least a pre-determined distance to release the locking pin from engagement with the device it is locking and into engagement with a pin release member. The pin release member holds the locking pin in the unlocked position until the pin release member is moved from engagement with the locking pin. Once moved, the pin release member disengages from the locking pin and the pin is moved back into its original, locked position. The shape memory alloy actuator and pin release member are also returned to their original position.

### TECHNICAL FIELD

This invention relates generally to a locking device with a shape memory alloy actuator, more specifically, to a locking device including a pin mechanism that is retracted by using a shape memory alloy.

### BACKGROUND

In various environments, especially for flight vehicles and projectiles, it is necessary to quickly and reliably release structural members for deployment yet securely hold such members in a retracted position for storage, transportation, or other pre-deployment requirements.

In certain applications such as smart bombs with movable wings or fins (for guidance), missiles with movable fins, and satellite or space vehicles and equipment with deployable panels (e.g., solar panels), it is desirable to provide a large margin of safety in design. For such situations, the fins or panels are biased towards their deployment position with a large force, often a spring force. The fins or panels, however, must be securely and reliably held in a retracted state prior to deployment. Premature deployment could easily damage the fins or panels, which could result in guidance malfunctions or cause other problems. Failure to deploy could result in an errant bomb or missile, or a satellite's premature loss of power.

In one proposed smart bomb design, a pin supported by plastic holds a first spring-biased member in a retracted position, which through mechanical linkage holds torsion springs in place. Mechanical linkage helps reduce the force to about 200 to 300 pounds needed to hold the spring-biased member in the locked position. When the pin is released, the torsion springs cause the fins to be unlocked and thus deployed. To obtain a quick release, a predetermined amount of explosive is ignited to break the plastic, thereby, releasing the pin.

Another system to release a locking element or pin as used in airborne vehicles and projectiles includes cutting a bolt, which holds two elements relative to each other, so as to release satellite photovoltaic panels and antenna reflectors. A further system involves weakening a nut, e.g., by cutting a portion of the nut, then exploding the nut at the time of deployment. These systems all involve destruction, and are thus cumbersome and expensive to handle, test and replace.

Systems which do not require such destruction are also known in the art, for example as disclosed in U.S. Pat. No. 6,948,685 (the '685 patent) and U.S. Pat. No. 7,125,058 (the '058 patent), which is a divisional thereof, both of which are assigned to the assignee of the present application. The '685 and '058 patents disclose a locking device with a solenoid to actuate release of the lock. The locking device includes a housing with a solenoid and a metal or magnetically responsive element disposed proximate or within a coil or coils of the solenoid. The responsive element (such as a plunger) is spring biased into its locked position. In such position, a lower portion of the responsive element (plunger) holds one or more balls, for example ball bearings, in a position where they protrude from the housing. In turn, the ball or balls hold a further element in a locked position. The portion of the magnetically responsive element (e.g., the bottom of the plunger) holding the balls includes a recess or recesses proximate but not in alignment with the ball or balls when in the locked position.

Shape memory alloys (SMA) have also found use in the aerospace industry. As the name implies, shape-memory-alloy actuators incorporate shape-memory alloys. These alloys have the ability to return to a predetermined shape when heated, such as by electrical current. This memory effect is due to their temperature-dependent crystallographic nature. When a shape memory allow is below its critical temperature, it becomes malleable and may be deformed into any arbitrary shape. Upon heating the shape memory alloy above the critical temperature, it undergoes a change in crystal structure and quickly resumes its stiff original shape. One commonly used shape-memory alloy is “Nitinol,” which is an alloy of nickel and titanium. Historically, SMA ejectors have been used in outer space to release (e.g., unlock, etc) deployables, such as solar panels, etc., in zero gravity. SMA ejectors/actuators are available from TiNi Aerospace, Inc., of San Leandro Cal.

One example of a shape-memory alloy actuator is disclosed in U.S. Pat. No. 6,367,253 (the '253 patent) where the shape memory alloy is used as an actuator for aircraft landing gear. The '253 patent discloses activating a shape memory alloy within a shape memory alloy spring strut to retract aircraft landing gear. Another example of a shape memory alloy actuator is disclosed in U.S. Pat. No. 7,464,634 (the '634 patent) where the shape memory alloy is used as an actuator for a missile cold-launch system. The '634 patent discloses a cold-launch missile that uses SMA actuators to accelerate materiel to a required launch velocity. The SMA actuators are arranged into one or more actuation stages. SMA actuators within a given actuation stage are simultaneously triggered. Actuation stages, however, are triggered sequentially, each triggering adding to the velocity of the materiel.

### SUMMARY

While conventional non-destructive actuators, such as solenoid actuators, have operated adequately, they are relatively heavy and include a number of components, which can add to the cost, and reliability of the actuator. Therefore, there is a need to develop actuators that weigh less, are less costly, and have fewer component parts than the prior art. Such actuators need to perform quickly and reliably for deployment, yet securely hold such members in a retracted position for storage, transportation, or other pre-deployment requirements, as described above. Although shape memory actuary actuators/ejectors are know in the art, they are conventionally composed of various component parts that add to their cost and increases the possibility of breakdown, thus possibly compromising the devices ability to operate and/or to perform quickly.

In order to reduce cost while still providing reliable and quick deployment, a locking device with a shape memory alloy actuator and method of use is provided. The locking device disclosed herein includes a shape memory alloy actuator that engages a locking pin and is operable to move the pin from a locked position to an unlocked position in order to release the pin from the device it is engaging. Upon heating the shape memory alloy member, it returns to an annealed predetermined shape which has a length that is shorter than its initial, non-heated length. In one embodiment, the shape memory alloy actuator is a wire that is received within a slot in the locking pin. As the shape memory alloy actuator shortens, it pulls the locking pin at least a pre-determined distance to release the locking pin from engagement with the device it is locking, for example a fin of a projectile. As the shape memory alloy actuator pulls the locking pin, the locking pin is moved into engagement with a pin release member. The pin release member holds the locking pin in the released or unlocked position until the pin release member is moved out of engagement with the locking pin. In order to move the pin release member out of engagement with the locking pin, the pin release member is retracted from engagement with the locking pin. In one embodiment, a user activates a handle operatively connected to the pin release member in order to manually retract the pin release member and disengage the shaft of the pin release member from a groove circumscribing the locking pin.

Once released, the locking pin returns to its original, locked position engaging the projectile or other device. The shape memory alloy actuator and pin release member are also returned to their original position and may be reactivated to again later release, retract and hold the pin member.

### BRIEF DESCRIPTION OF THE DRAWINGS

The foregoing and other objects, features and advantages will be apparent from the following description of particular embodiments of the invention, as illustrated in the drawings which are integrated within this document.

FIG. 1 is a side perspective view of a locking member with a shape memory alloy actuator according to the present invention;

FIG. 2 is an exploded view of the locking member of FIG. 1;

FIG. 3 is a top perspective view of a locking member of FIG. 1;

FIG. 4 is a cross-sectional view of the locking member of FIG. 1 in a locked or engaged position;

FIG. 5 is a cross-sectional view of the locking member of FIG. 1 moving into an unlocked position;

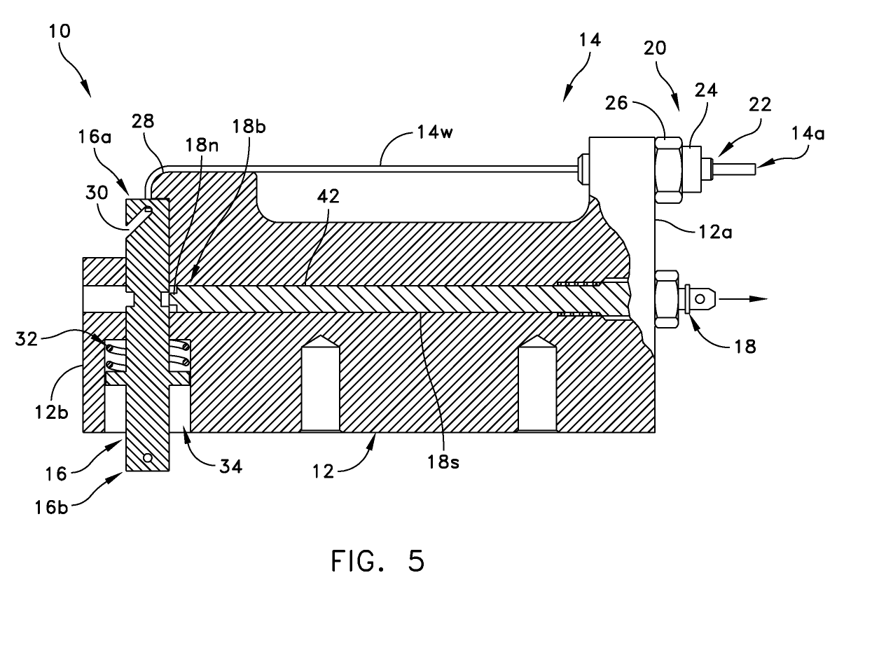

FIG. 6 is a cross-sectional view of the locking member of FIG. 1 in an unlocked or disengaged position;

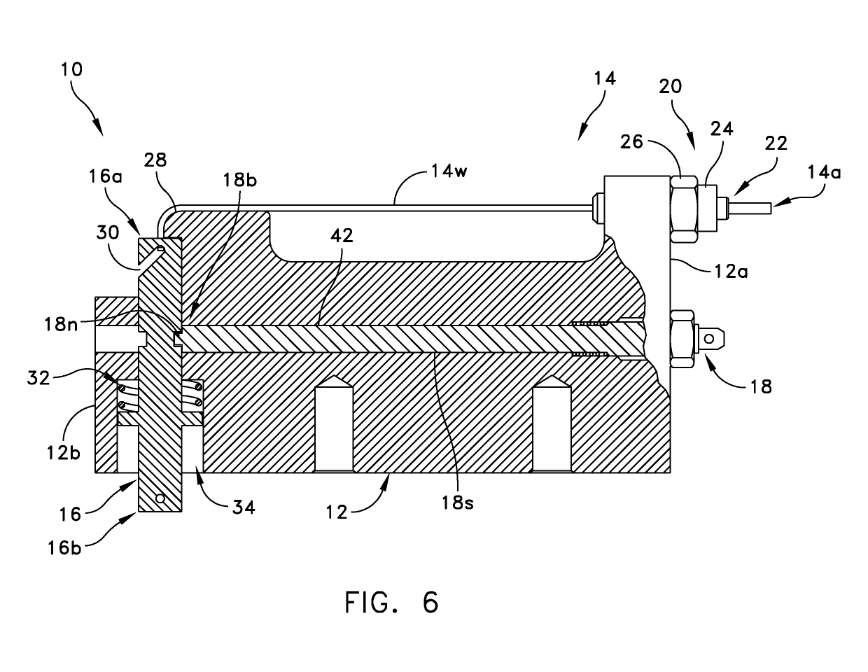

FIG. 7 is a cross-sectional view of the locking member of FIG. 1 with the pin release member disengaged from the locking pin and the locking pin moving back toward the locked position; and

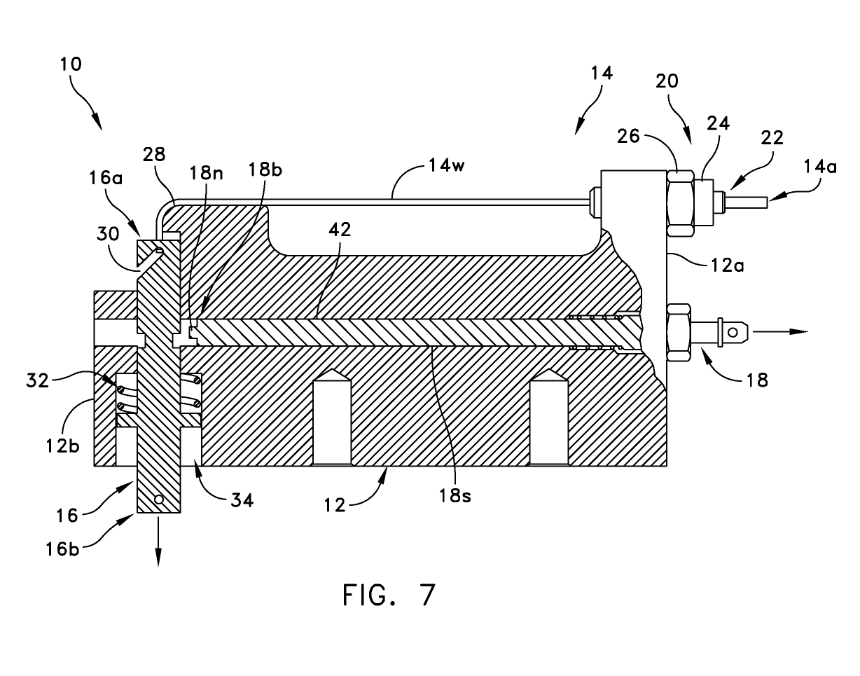

FIG. 8 is a chart equating anticipated shape memory alloy retract temperatures.

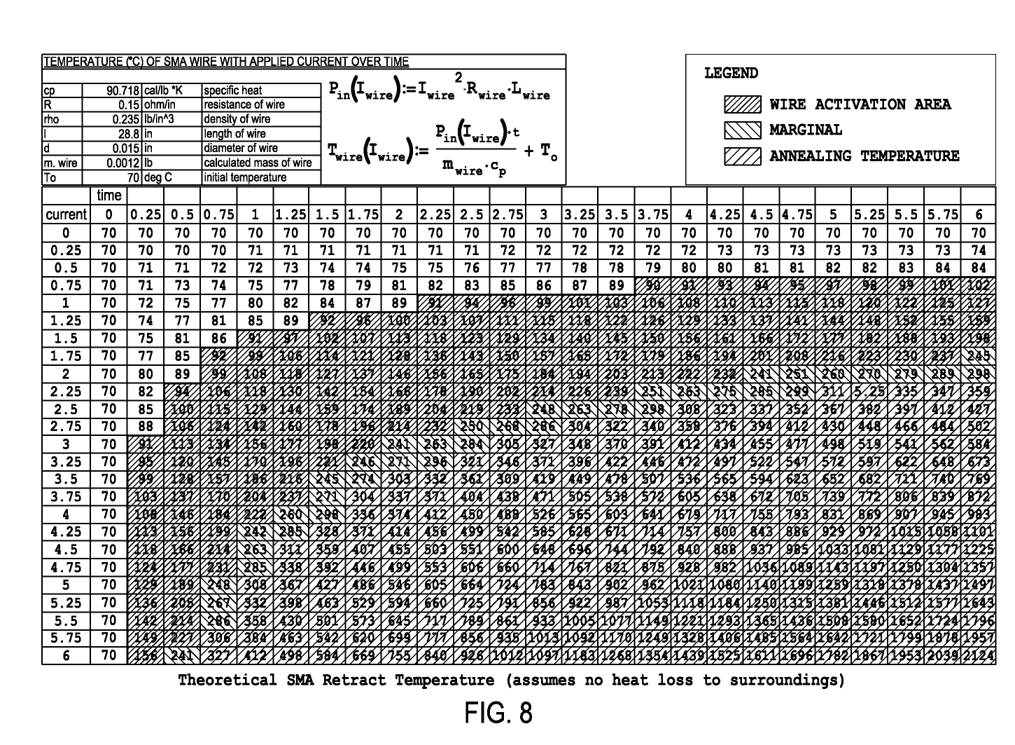

### DETAILED DESCRIPTION

A locking device including a shape memory alloy (SMA) actuator that engages and moves a locking pin between a locked position and an unlocked position is disclosed herein. When heated, the shape memory alloy actuator returns to a predetermined shape that has a length that is shorter than its initial, non-heated length, in order to retract and unlock the locking pin, as described in greater detail below. Although described herein with respect to locking a structural member of a projectile, such as a missile or smart bomb, it is understood that the locking device described herein may find other applications where cost, ease of manufacture and use are important, for example, in other aerospace, solar, and automotive applications.

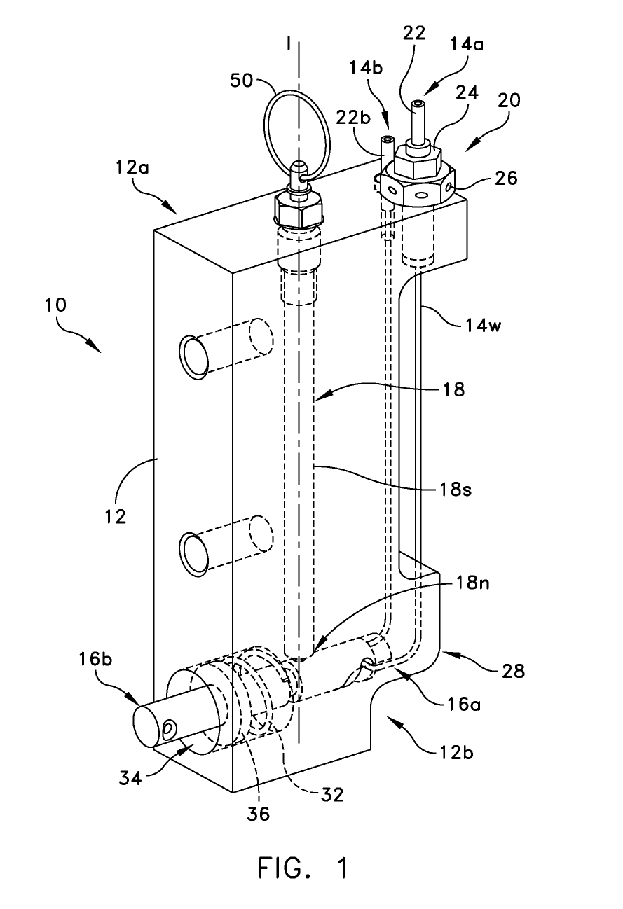

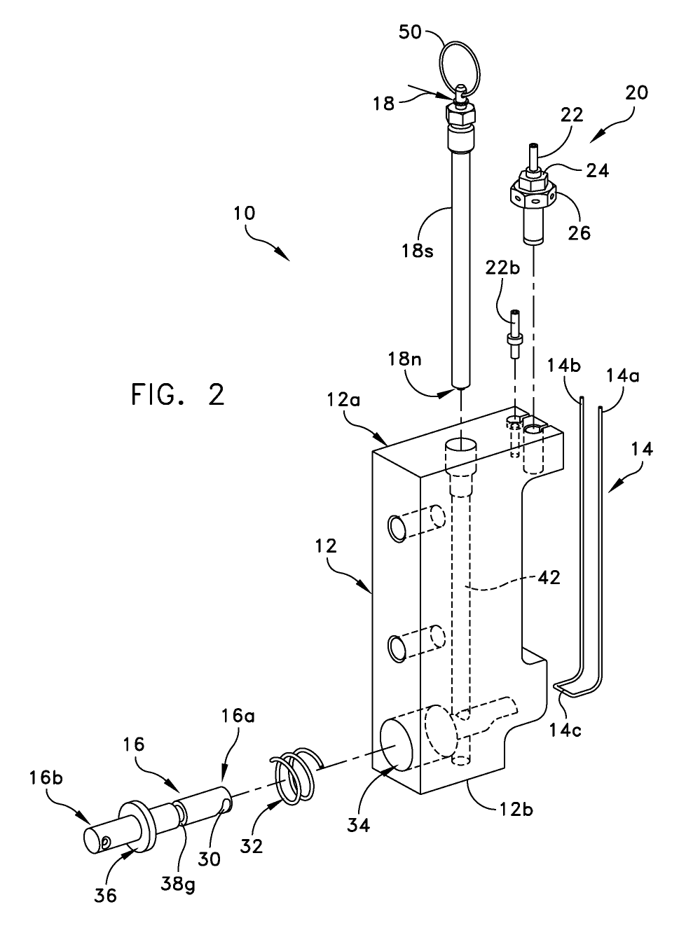

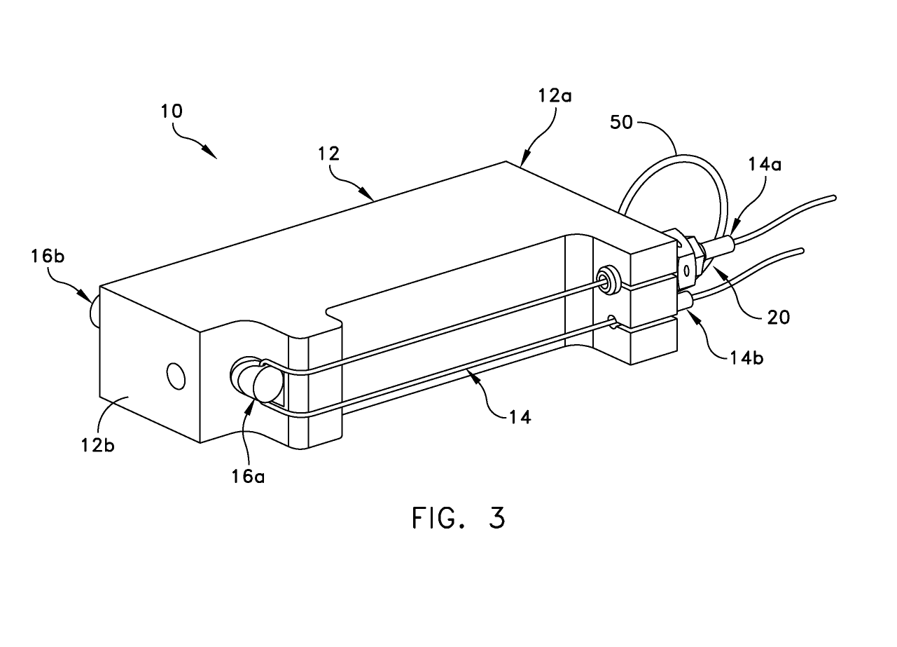

Referring initially to FIGS. 1-3, locking device 10 includes a housing 12 that supports a locking pin 16, an SMA actuator 14 that engages and retracts the locking pin 16 from engagement with the structural member of the device it is locking (not shown), and a pin release member 18 that holds the locking pin 16 in the retracted position and releases the locking pin 16 to return it to its original, locked position.

Housing 12 includes a first end 12a, a second end 12b (opposite the first end), and defines a longitudinal axis “1” extending there between. In the present embodiment, the SMA actuator 14 may be formed as a wire 14w that has a first end 14a supported by the first end 12a of the housing, the wire 14w extending longitudinally along the housing 12 and having a length sufficient to engage the locking pin 16. An adjustment assembly 20 may be provided to secure the first end 14a of the SMA actuator wire 14w to the first end 12a of the housing. In the present embodiment, the adjustment assembly 20 may include a ferrule 22 to secure the first end 14a of the SMA actuator wire 14w to the housing 12, for example by crimping; an adjustment member 24 (e.g., a screw), that is adjusted to remove slack from the SMA actuator wire 14w in its initial, non-retracted position, and a locking member 26 (e.g., a locking nut), to further secure the SMA actuator wire. The SMA actuator wire 14w also has a second end 14b that is also supported by the first end 12a of the housing 12, adjacent the first end 14a of the SMA actuator wire 14w, where it may be secured by a second ferrule 22b, or other element, as would be known to those of skill in the art.

The SMA actuator wire 14w is supported at the first end 12a of the housing 12, extends longitudinally from the first end 12a, out of the housing 12 over a rounded edge 28 formed in the second end 12b of the housing 12. The edge 28 is preferably rounded so that it can support and allow the SMA actuator wire 14w to smoothly glide over the edge as it pulls locking pin 16. Although a pulley member could alternatively be utilized, a rounded edge is included to reduce cost and simplify the mechanism. As the wire extends over the rounded edge 28 of the housing 12 it engages a proximal end 16a of the locking pin 16 that extend from the housing. As illustrated, the proximal end of 16a of the locking pin 16 includes a slot 30 formed therein for receiving a central portion 14c of the length of the SMA actuator wire 14w. In the present embodiment, the slot 30 is formed on a diagonal from a longitudinal axis of the locking pin 16. The diagonal slot 30 is provided to maintain the central portion 14c of the wire therein because when the shape memory alloy wire cools and lengthens slack develops in the wire. By providing a diagonal slot 30, as SMA actuator wire 14w becomes slack it does not become disengaged from the locking pin 16 but, instead, remains captured by the diagonal slot. The remaining length of the SMA actuator wire 14w extends longitudinally back toward the first end 12a of the housing where it is secured, as described above.

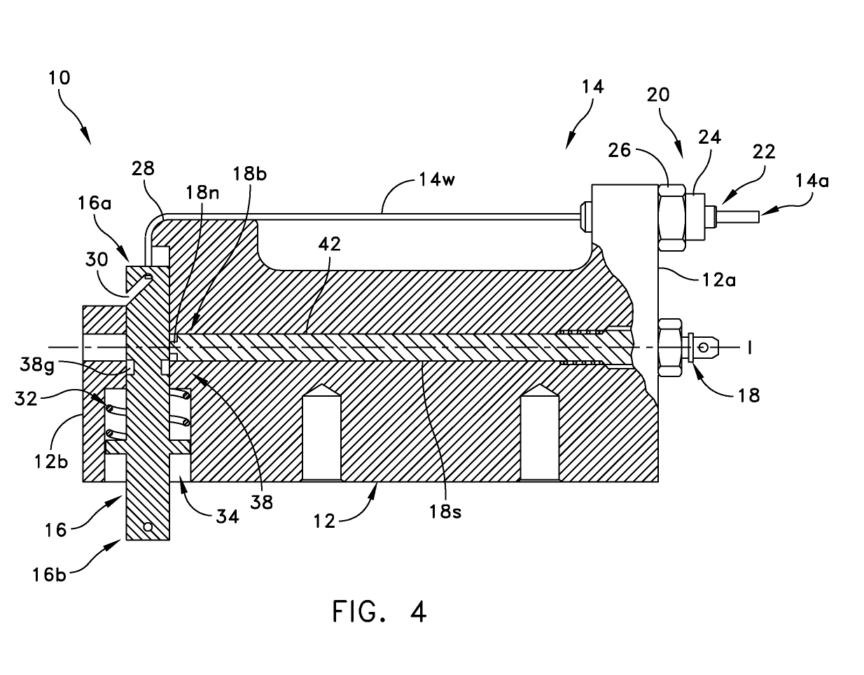

In order to activate the SMA actuator wire 14w, it is heated above its critical or activation temperature, for example by an electrical current. Heating the SMA actuator wire 14w to the activation temperature returns it to its predetermined length that is formed through annealing, or its annealed length. The shape memory alloy may be any conventionally available shape memory alloy, for example a nickel and titanium alloy aka “Nitinol”. In the present embodiment, the Nitinol alloy has an activation temperature above about 90° C., an ambient temperature at below about 70° C., and an annealing temperature above about 300° C. When raised to the activation temperature the response time for the SMA actuator wire 14w to return to the annealed length is ideally about 0.5 of a second, but will vary depending upon the applied current and ambient temperature, as best illustrated in the chart of FIG. 4. In the present embodiment, the SMA actuator wire 14w has an annealed length that is shorter than its initial, non-heated length. Thus, as the shape memory alloy is activated through heating, the length of the SMA actuator wire shortens and the central portion 14c disposed within slot 30 pulls the proximal end 16a of the locking pin 16 at least a pre-determined distance to release the distal end 16b of the locking pin from engagement with the structural member of the device it is locking.

The locking pin 16 may also includes a compression member 32 (e.g., a compression spring), disposed within a bore 34 in the housing 12. The compression member 32 may be supported adjacent the distal end 16b of the locking pin 16 by a shelf 36 formed within the housing 12, as illustrated in the present embodiment. The shelf 36 may be formed as a separate element, for example as a snap ring, or could be formed as a unitary member with the locking pin 16, as would be known to those of skill in the art. The compression member 32 applies a force to hold the distal end 16b of the locking pin 16 in engagement with the structural member of the device it is locking. In order to release the locking pin 16 from engagement with the structural member, the SMA actuator wire 14w pulling on the locking pin 16 must overcome the force of the compression member 32 in order to move the distal end of the locking pin 16 a sufficient distance to disengage it from the structural member.

Once released, a stop member 38 may hold the locking pin 16 in the released or unlocked position for any desired amount of time. In the present embodiment, in order to hold the locking pin 16 in the released position, the stop member is formed as a circumferential groove 38g circumscribing the locking pin 16, the groove 38 being sized to receive a portion of the pin release member 18 therein. The groove 38g is positioned on the locking pin 16 between the slot 30 and the compression member 32, in the present embodiment, to hold the locking pin 16 a sufficient distance from the structural member in the unlocked position. Alternatively, other types of stop members may be utilized for example a detent, or flange, as would be known to those of skill in the art.

As illustrated, the pin release member 18 includes a shaft 18s that is disposed in a longitudinal channel 42 formed in housing 12. The pin release member 18 may include a first end 18a having a threaded portion that mate with corresponding threads in channel 42 adjacent the first end 12a of the housing 12 to secure the first end 18a to the housing.

The pin release member 18 also has a second end 18b (opposite the first end), having a portion extending there from that engages groove 38 formed in the locking pin 16. In the present embodiment, the second end 18b includes a nub 18n having a diameter smaller than that of the shaft 18s, the nub 18n being sized to fit within the groove 38g of the locking pin 16. The pin release member 18 is preloaded by a force-producing member that applies a force to the shaft 18s to provide for initial and continued engagement of the second end 18b with the groove 38 of the locking pin 16 during use. In the present embodiment, the force-producing member is a spring 48. In this manner, as the groove 38 is moved into alignment with the channel 42, the force applied by spring 48 moves the nub 18n supported by shaft 18s into engagement with the groove 38. The individual pin release member 18 disclosed herein is available conventionally from Pivot Point Inc, of Hustisford, Wis. Alternately, other shape, size and type of release mechanisms may be utilized provided that the locking pin 16 is maintained in the unlocked position.

In order to disengage the nub 18n from within groove 38, a handle or ring 50 is provided in the present embodiment that is operatively connected to the first end 18a of the pin release member 18, exterior to the housing. The pin release member 18 is manually retracted by a user applying a force on the handle 50 sufficient to overcome the force of spring 48 in order to move the shaft 18s within the channel 42 in a direction away from the locking pin 16, i.e. toward the first end of the housing 14a. Once nub 18n is released from groove 38 of the locking pin, the compression member 32 forces the distal end 16a of the locking pin 16 back into its original, locked position, engaging the structural member it is configured to lock. The shape memory alloy actuator and pin release member 18 are also returned to their original position and may be reactivated to again later release, retract and hold the pin member.

It will be noted that in the present embodiment, the SMA wire 14w does not maintain the locking pin 16 in the released position in order to save energy that would be needed to continue to heat the shape memory alloy in order to maintain it in its activated, shortened length. However, it is possible for the shape memory alloy to maintain the locking pin in the released position if the shape memory alloy is kept above its activation temperature, and for the shape memory alloy to thereafter be cooled and lengthened in order to again engage the locking pin with the structural member of the device it is configured to lock.

While various embodiments of the invention have been particularly shown and described, it will be understood by those skilled in the art that various changes in form and details may be made therein without departing from the spirit and scope of the invention as defined by the appended claims. For example, various shape memory alloys may be used as an alternative to Nitinol, the SMA actuator may have other shapes and/or dimensions, and alternatives to the fasteners disclosed herein may be utilized as may the springs by other force applying members, as would be known to those of skill in the art. Likewise, the charts and examples provided are not to be construed as limiting, but as projected outcomes of exemplary embodiments.

Therefore, the above description should not be construed as limiting, but merely as exemplifications of preferred embodiments.

What is claimed is:

1. A locking device for securing a structural member, the locking device comprising:
a housing having a first end, a second end opposite the first end, and a longitudinal axis extending there between;
a locking pin supported by the housing and including a distal end constructed and arranged to engage the structural member, a proximal end opposite the distal end, the locking pin being movable between a locked position engaging the structural member and an unlocked position disengaged from the structural member;
a shape memory alloy actuator having a first end, a second end opposite the first end, an initial length extending there between at a first temperature and an annealed length extending there between at an activation temperature, the shape memory alloy actuator being operatively connected to the proximal end of the locking pin and constructed and arranged to move the pin into the unlocked position upon the shape memory alloy actuator reaching the activation temperature;
a pin release member including a shaft having a first end extending from the housing and a second end movable between an engaged position wherein the pin release member holds the locking pin in the unlocked position, and a release position wherein the pin release member is released from engagement with the locking pin; and
wherein as the shape memory alloy reaches the activation temperature it shortens to the annealed length causing the locking pin to move at least a sufficient distance to release the locking pin from engagement with the structural member, and into engagement with the pin release member, which holds the locking pin in the unlocked position until released.

2. The locking device of claim 1, further comprising a stop member disposed between the distal end and proximal end of the locking pin, the stop member engaging the pin release member as the locking pin is moved to the unlocked position so as to hold the locking pin in the unlocked position until released.

3. The locking device of claim 1, wherein the shape memory alloy actuator is formed as a wire and wherein:
a. the first end of the shape memory actuator wire is supported at a first end of the housing and extends there from;
b. the initial length of the shape memory alloy actuator wire extends longitudinally across the housing, and a central portion of the initial length extends over a second end of the housing and into engagement with the proximal end of the locking pin; and
c. the second end of the shape memory actuator wire is supported at the first end of the housing, adjacent the first end of the shape memory alloy actuator wire.

4. The locking device of claim 3, wherein the shape memory actuator wire is formed of a nickel and titanium alloy.

5. The locking device of claim 3, wherein the first end of the shape memory actuator wire is further supported by an adjustment assembly that is constructed and arranged to apply a preloaded force to the wire.

6. The locking device of claim 5, wherein the adjustment assembly includes;
a. a ferrule constructed and arranged to secure the first end of shape memory actuator wire to the housing;
b. an adjustment member constructed and arranged to remove slack from the shape memory actuator wire along its initial length; and
c. a locking member constructed and arranged to further secure the shape memory actuator wire to the housing.

7. The locking device of claim 3, wherein the second end of the housing includes a rounded edge, the central portion of the shape memory alloy actuator wire extending over the rounded edge and into engagement with the locking pin.

8. The locking device of claim 7, wherein the locking pin includes a slot disposed in the proximal end, and wherein the central portion of the shape memory alloy actuator wire extending over the rounded edge is captured within the slot.

9. The locking device of claim 8, wherein the slot is formed in the locking pin on a diagonal from a longitudinal axis of the locking pin to maintain the shape memory alloy actuary wire within the slot as the length of the shape memory alloy wire changes between the initial length and the activation length.

10. The locking device of claim 2, wherein the stop comprises a groove formed in the locking pin, the groove being sized to receive the second end of the pin release member.

11. The locking device of claim 10, wherein pin release member is preloaded by a force-producing member that is constructed and arranged to apply a force to the shaft sufficient to hold the second end within the groove of the locking pin to maintain the pin in the unlocked position.

12. The locking device of claim 11, wherein the second end of the pin release member further includes a nub having a diameter smaller than a diameter of the shaft of the pin release member, the nub being sized to fit within the groove of the locking pin.

13. The locking device of claim 10, wherein the pin release member further includes a threaded portion constructed and arranged to mate with corresponding threads in the channel, adjacent the first end of the housing, in order to secure the first end of the pin release member to the housing.

14. The locking device of claim 1, further comprising a compression member constructed and arranged to apply a force to the locking pin sufficient to hold the distal end of the locking pin in engagement with the structural member.

15. The locking device of claim 14, wherein the compression member is a compression spring supported adjacent the distal end of the locking pin by a shelf formed within the housing.

16. A method of releasing a locking device having a shape memory alloy actuator operatively engaged with a locking pin from a structural member that the locking pin is engaging, the method comprising:
raising the initial temperature of the shape memory alloy actuator to an activation temperature wherein an initial length of the shape memory alloy shortens to an annealed length;
causing the locking pin to move from engagement with the structural member to an unlocked position out of engagement with the structural member by shortening the initial length of the shape memory alloy actuator to the annealed length; and
moving a pin release member into an engaged position with the locking pin in order to maintain the locking pin in the unlocked position.

17. The method of claim 16, further comprising the step of engaging a stop on the locking pin with the pin release member so as to maintain the locking pin in the unlocked position.

18. The method of claim 16, further comprising the steps of disengaging the pin release member from the locking pin and moving the locking pin back into engagement with the structural member.

19. A locking device for securing a structural member, the locking device comprising:
a housing having a first end, a second end opposite the first end, the second end of the housing including a rounded edge, and a longitudinal axis extending between the first end and the second end;
a locking pin supported by the housing and including a proximal end having a slot disposed therein, a distal end opposite the proximal end constructed and arranged to engage the structural member, and a stop member disposed distal to the slot, the locking pin being movable between a locked position engaging the structural member and an unlocked position disengaged from the structural member;
a shape memory alloy actuator constructed and arranged to move the pin into the unlocked position upon the shape memory alloy actuator reaching an activation temperature, the shape memory alloy actuator including:
a. a first end supported at a first end of the housing and extending there from;
b. a second end opposite the first end, the second end being supported at the first end of the housing, adjacent the first end of the shape memory alloy actuator;
c. an initial length extending between the first end and the second end of the shape memory alloy actuator at an initial temperature; and
d. a central portion of the initial length extending over the rounded edge of the second end of the housing and into engagement with the slot disposed in the locking pin;
a pin release member including a shaft having a first end extending from the housing and a second end movable between an engaged position wherein the pin release member holds the locking pin in the unlocked position, and a release position wherein the pin release member is released from engagement with the locking pin;
a force-producing member constructed and arranged to apply a force to the shaft of the pin release member sufficient to hold the second end of the pin release member in engagement with the stop of the locking pin;
wherein as the shape memory alloy reaches the activation temperature the shape memory actuator is shortened from the initial length to an activation length, the shortened activation length moving the shape memory alloy into an initial, annealed position and wherein as the shape memory alloy actuator moves into the annealed position it causes the locking pin to move at least a sufficient distance to release the locking pin from engagement with the structural member into the unlocked position and further into engagement with the pin release member wherein the locking pin is held in the unlocked position until released.

20. The locking device of claim 19, wherein the stop comprises a groove formed in the locking pin.

21. The locking device of claim 20, wherein the second end of the pin release member further includes a nub having a diameter smaller than a diameter of the shaft of the pin release member, the nub being sized to fit within the groove of the locking pin.

22. The locking device of claim 19, further comprising a compression member constructed and arranged to apply a force to the locking pin sufficient to hold the distal end of the locking pin in engagement with the structural member.
